(19) United States
(12) Patent Application Publication
(10) Pub. No.: US 2023/0212375 A1
(43) Pub. Date: Jul. 6, 2023

(54) ANTI-OZONANT COMPOSITION FOR A CROSSLINKED RUBBER ARTICLE

(71) Applicant: COMPAGNIE GENERALE DES ETABLISSEMENTS MICHELIN, Clermont-Ferrand (FR)

(72) Inventors: SEBASTIEN FERREIRA, Clermont-Ferrand (FR); GAELLE AVRIL, Clermont-Ferrand (FR)

(21) Appl. No.: 17/928,449

(22) PCT Filed: May 26, 2021
(86) PCT No.: PCT/FR2021/050949

§ 371 Date: Nov. 29, 2022

(30) Foreign Application Priority Data
May 29, 2020 (FR) FR2005702

(51) Int. Cl. C08L 15/02; C08K 5/01; C08K 5/07

(52) U.S. Cl. CPC C08L 15/02; C08K 5/01; C08K 5/07; C08L 2201/08

(57) ABSTRACT

An anti-ozone protective composition for a crosslinked rubber article; is based on at least one chlorinated elastomer, at least one hydrocarbon solvent and at least one polar aprotic solvent. A rubber article comprises at least one elastomeric surface in contact with air, said surface being completely or partly coated with said composition.

The invention relates to an anti-ozone protective composition for a crosslinked rubber article, the composition being based on at least one chlorinated elastomer, at least one hydrocarbon solvent and at least one polar aprotic solvent.

Crosslinked rubber articles, such as for example pneumatic or non-pneumatic tyres, are generally based on diene polymers comprising ethylenic double bonds in their main chain. These polymers are sensitive to the action of ozone due to the presence of these double bonds.

When a crosslinked article produced with these polymers is subjected to a stress in the presence of ozone, the harmful action of ozone is revealed by the appearance of crazing or cracks which are visible on the surface of the article. This crazing is oriented substantially perpendicular to the direction of said stress, and their propagation under the effect of the persistence of such a stress may in time cause complete rupture of this article.

To limit this degradation, compositions based on diene polymers commonly incorporate anti-ozone chemical compounds and also waxes. Anti-ozone chemical compounds slow the formation and propagation of cracks under static and dynamic stress conditions. Waxes provide additional protection under static conditions via the formation of a protective surface coating.

However, the use of these anti-ozone chemical compounds and/or of these waxes leads to the appearance of marks on the surface of these rubber articles due to their ability to migrate to the surface. This phenomenon is known as blooming. To preserve the surface appearance of tyres, there is therefore a tendency to limit the proportion of these compounds in the rubber compositions, and consequently their action. Furthermore, the proportions of waxes and of antiozonant compounds are limited due to problems of cohesion of the mixture and in order to preserve the properties of the rubber compositions.

However, this limitation of the content of anti-ozonant agents (also referred to as anti-ozone agents) and of waxes is not very compatible with certain uses of rubber articles, such as for example pneumatic tyres, in particular intended to be fitted to aircraft. This is because, as is known, an aircraft pneumatic tyre must withstand high pressure, load and speed conditions, in particular on landing, where they have to change from zero speed to a very high speed, causing considerable heating and wear. These particular wear conditions do not affect other types of tyres, such as the tyres of passenger, heavy-duty, construction plant or off-road vehicles. In particular, an aircraft tyre is subjected to high stresses during the landing (touch down) phases.

The particular conditions of use of aircraft pneumatic tyres have the effect that crack initiations which are created in the tread under the effect of ozone tend to propagate further and faster than those which would be created on other types of pneumatic tyres such as passenger vehicle tyres. These crack initiations and cracks damage the treads of the pneumatic tyre and therefore reduce the service life of said tyre. In view of their particular conditions of use, aircraft pneumatic tyres therefore need more effective anti-ozone protection than those of other pneumatic tyres. Solutions, other than those of the limiting the anti-ozonants, have been proposed to overcome the aforementioned problem. For example, one solution consists in depositing, on the surface to be protected of the tyre intended to be fitted to an aircraft, one or more layers of an anti-ozone protective coating. A coating is known from document EP0728810A1 consisting of an aqueous composition based on polymers selected from the group of acrylic, methacrylic and vinyl esters, a constituent comprising a hydrophilic silica and a polymer of which the monomer is selected from acrylic, methacrylic and vinyl monomers. However, due to the fact that this composition exhibits poor adhesion to a rubber surface, it must be deposited in several goes, with very thin layers each time. This restrictive application as several layers results in a coating thickness that is difficult to control and in nonuniform distributions of the coating.

Another anti-ozone coating composition for pneumatic tyres is also known from document WO2001/094453A1. This composition is based on polyurethane polymers. The disadvantage of this composition is a complicated implementation requiring a first step of functionalizing the rubber support with a functionalizing solution, followed by a drying step which may be relatively long, and only then the deposition of the coating composition. The bond between the elastomer of the pneumatic tyre and the polyurethane is achieved by means of the polar functions of the functionalizing solution. Its ozone protection effectiveness is therefore dependent on the step of functionalizing the support, since this step enables the adhesion of the polyurethane layer to its support.

There is therefore still a need for an anti-ozone protective composition for a crosslinked rubber article which is simple to use and which provides good protection against ozone attack.

One aim of the present invention is to meet this need.

This aim is achieved by means of an anti-ozone protective composition for a crosslinked rubber article, notably for a crosslinked pneumatic tyre, in particular intended to be fitted to aircraft, based on at least one chlorinated elastomer, at least one hydrocarbon solvent and at least one polar aprotic solvent.

This composition is particularly advantageous and easy to use. It is not necessary to functionalize the crosslinked rubber support, the composition is applied directly to the crosslinked support, in a single step, which has the advantage of being able to produce a layer of uniform thickness.

This composition advantageously makes it possible to form a continuous, flexible, adherent coating on any surface of the pneumatic tyre which, by its presence, opposes degradation due to ozone. The rubbery behaviour of this composition advantageously makes it possible to withstand all the deformations undergone by the crosslinked rubber article. For example, this composition is advantageously used to protect pneumatic tyres, notably intended to be fitted to aircraft, since it withstands the deformations undergone after the manufacture of the tyres, in particular during the inflation and subsequent use of said tyre. It also has the advantage of being able to be applied to any crosslinked rubber surface, and in particular to new or retreaded tyres.

Another subject of the present invention relates to a crosslinked elastomeric article having at least one elastomeric surface in contact with air, said elastomeric surface being completely or partly coated with an anti-ozone protective composition as defined above. Advantageously, the crosslinked elastomeric article is selected from pneumatic tyres, non-pneumatic tyres, conveyors, seals, shoe soles, caterpillar tracks, tubes, hoses, windscreen wipers, table tennis bats and floor coverings. More advantageously still, the crosslinked elastomeric article is a crosslinked pneumatic or non-pneumatic tyre, at least one outer layer of which is at least partly coated with an anti-ozone protective composition as defined above.

### BRIEF DESCRIPTION OF THE DRAWINGS

FIG. 1: photograph of a groove of a tread of an aircraft pneumatic tyre comprising zones protected by the protective composition according to the invention and zones not protected by the protective composition of the invention.

Line A-A and line B-B delimit the zones which have or have not been protected by the protective composition of the invention. The zone delimited in a rectangle by the lines A-A and B-B was not subjected to an application of the protective composition according to the invention. Wide cracks are visible inside this rectangle. In contrast, in the protected zones, that is to say between the top of the photo and the line A-A and between the line B-B and the bottom of the photo, there are no cracks.

FIG. 2: photograph of a groove of a tread of an aircraft pneumatic tyre; in which groove the protective composition according to the invention has been applied. No cracks are visible.

FIG. 3: photograph of two grooves of a tread of an aircraft pneumatic tyre; in which grooves no protective composition according to the invention has been applied. Many cracks are visible in the bottom of these grooves.

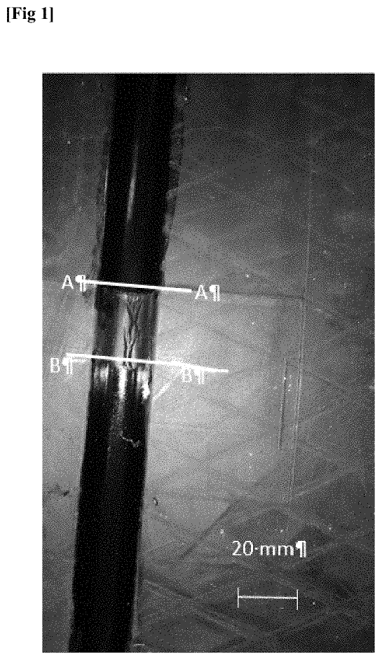

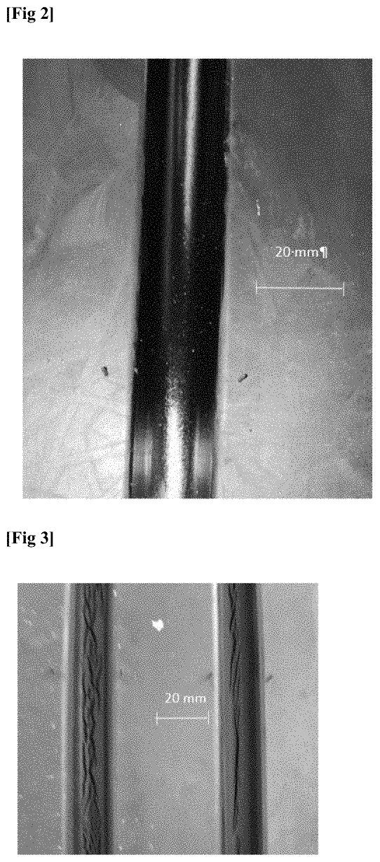

### DETAILED DESCRIPTION

A first subject of the invention relates to an anti-ozone protective composition for a crosslinked rubber article, notably for a crosslinked pneumatic tyre, in particular intended to be fitted to aircraft, the composition being based on at least one chlorinated elastomer, at least one hydrocarbon solvent and at least one polar aprotic solvent.

A “rubber article” or “elastomeric article” is understood to mean an object comprising one or more elastomers, in particular one or more diene elastomers. This rubber article comprises at least one rubber surface (also referred to as an elastomeric surface) in contact with air. A “crosslinked rubber article” it is understood to mean, for the purposes of the present invention, a rubber article that has undergone a crosslinking step, that is to say that the rubber or the elastomers forming this article are in the form of a network obtained by establishing bridges between the macromolecular chains of the rubber or of said elastomers. The formation of bridges can be carried out by any known crosslinking agent, such as for example peroxides or else by sulfur. When the crosslinking agent is sulfur, it is then referred to as vulcanization.

“Diene elastomer (or, without distinction, rubber)”, whether natural or synthetic, should be understood, in a known way, as meaning an elastomer composed, at least in part (i.e., a homopolymer or a copolymer), of diene monomer units (monomers bearing two conjugated or non-conjugated carbon-carbon double bonds). These diene elastomers can be classified into two categories: “essentially unsaturated” or “essentially saturated”. The term “essentially unsaturated” is understood to mean generally a diene elastomer resulting at least in part from conjugated diene monomers having a content of units of diene origin (conjugated dienes) which is greater than 15% (mol %); thus it is that diene elastomers such as butyl rubbers or copolymers of dienes and of α-olefins of EPDM type do not come within the preceding definition and can in particular be described as “essentially saturated” diene elastomers (low or very low content, always less than 15 mol %, of units of diene origin). A diene elastomer capable of being used in the elastomeric articles in accordance with the invention is intended particularly to mean:
any homopolymer of a conjugated or non-conjugated diene monomer having from 4 to 18 carbon atoms;
any copolymer of a conjugated or non-conjugated diene having from 4 to 18 carbon atoms and of at least one other monomer.

The expression “composition based on” should be understood to mean a composition comprising the mixture and/or the product of the in situ reaction of the various constituents used, some of these constituents being able to react and/or being intended to react with one another, at least partially, during the various phases of manufacture of the composition and/or during the use of this composition.

The expression “phr” should be understood as meaning, for the purposes of the present invention, the part by weight per hundred parts by weight of elastomer.

In the present document, unless expressly indicated otherwise, all the percentages (%) indicated are percentages (%) by weight.

Moreover, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

When reference is made to a “predominant” compound, this is understood to mean, for the purposes of the present invention, that this compound is predominant among the compounds of the same type in the composition, that is to say that it is the one which represents the greatest amount by weights among the compounds of the same type. Thus, for example, a predominant elastomer is the elastomer representing the greatest weight relative to the total weight of the elastomers in the composition. In the same way, a “predominant” filler is that representing the greatest weight among the fillers of the composition. By way of example, in a system comprising just one elastomer, the latter is predominant for the purposes of the present invention and, in a system comprising two elastomers, the predominant elastomer represents more than half of the weight of the elastomers.

The compounds mentioned in the description that comprise carbon may be of fossil origin or may be biobased. In the latter case, they may be partially or completely derived from biomass or may be obtained from renewable starting materials derived from biomass. These notably include polymers, solvents and additives.

Chlorinated Elastomer

The anti-ozone protective composition of the invention comprises at least one chlorinated elastomer. A “chlorinated elastomer” is understood to mean a polymer which comprises one or more chlorine atoms and which is flexible and deformable, exhibiting rubber-like elasticity according to the IUPAC definition of elastomers.

Preferentially, the chlorine content of the chlorinated elastomer is within a range extending from 20% to 50% by weight relative to the total weight of the elastomer, more preferentially within a range extending from 25% to 45%, more preferentially still extending from 30% to 37% by weight relative to the total weight of the elastomer. The chlorine content in the elastomer is measured according to standard elastomer analysis techniques.

Preferentially, the chlorinated elastomer has a Mooney viscosity index ML(1+4) at 100° C. within a range extending from 20 to 100 MU, more preferentially extending from 25 to 60 MU. The Mooney viscosity index is measured according to the standard ASTM D-1646-2015 and is expressed in “Mooney units” (MU, with 1 MU=0.83 Nm).

Among the abovementioned chlorinated elastomers, polychloroprene, chlorosulfonated polyethylene and mixtures of these elastomers may more specifically be suitable. These elastomers are available from suppliers such as Du Pont de Nemours, Lianda, etc.

Preferentially, the chlorinated elastomer is a chlorosulfonated polyethylene, in particular having a sulfur content within a range extending from 0.8% to 2% by weight relative to the total weight of the polyethylene, more particularly within a range extending from 0.9% to 1.5%, more preferentially extending from 1% to 1.5% by weight. The sulfur content in the elastomer is measured according to the standard polymer analysis techniques. Chlorosulfonated polyethylenes are manufactured by simultaneous functionalization and modification of polyethylene using chlorine and sulfur dioxide. They are sold under the name CSM.

Particular embodiments of the present invention may comprise at least one chlorosulfonated polyethylene having a chlorine content within a range extending from 20% to 50% by weight and a sulfur content within a range extending from 0.8% to 2% by weight, more preferentially may comprise at least one chlorosulfonated polyethylene having a chlorine content within a range extending from 25% to 45% by weight and a sulfur content within a range extending from 0.9% to 1.5%, more preferentially still, may comprise at least one chlorosulfonated polyethylene having a chlorine content within a range extending from 30% to 37% and a sulfur content within a range extending from 0.8% to 1.2%. The chlorine content and the sulfur content in the elastomer are expressed in % by weight relative to the total weight of the chlorosulfonated polyethylene.

Preferably, the content of the chlorinated elastomer, preferably of polychloroprene and/or of chlorosulfonated polyethylene, in the composition is within a range extending from 3% to 25% by weight relative to the total weight of the composition, more preferentially in a range extending from 5% to 20% by weight relative to the total weight of the composition. Below 3% by weight of chlorinated elastomer in the composition, the concentration is too low to obtain the expected effects and above 25% by weight the composition becomes very viscous and difficult to apply.

The choice of the concentration of chlorinated elastomer depends on the optional need, for the elastomeric surface to be protected, for a significant final protective thickness and on the conditions of use of this surface. If the rubber article is used in an atmosphere with high concentrations of ozone, then the highest concentration of chlorinated elastomer will preferably be chosen in order to reduce the number of layers to be applied and to obtain the best protection.

Hydrocarbon Solvent

The anti-ozone protective composition according to the invention comprises at least one hydrocarbon solvent. A “hydrocarbon solvent” is understood to mean a solvent containing mainly carbon atoms and hydrogen atoms. The hydrocarbon solvent is liquid at ambient temperature (20° C.) and at atmospheric pressure.

Preferentially, the hydrocarbon solvent is an aliphatic hydrocarbon solvent. It may have a distillation range within a range of from 50° C. to 220° C.

Advantageously, the hydrocarbon solvent that can be used in the context of the invention is a C4-C14, preferably C5-C10, more preferentially still C7-C9 aliphatic hydrocarbon solvent.

The hydrocarbon solvent is preferentially volatile at ambient temperature (20° C.) and has a non-zero vapour pressure, at ambient temperature (20° C.) and atmospheric pressure, and in particular a vapour pressure ranging from 0.13 Pa to 40 000 Pa, in particular ranging from 1.3 Pa to 13 000 Pa, and more particularly ranging from 1.3 Pa to 1300 Pa.

Polar Aprotic Solvent

The anti-ozone protective composition according to the invention also comprises at least one polar aprotic solvent. A “polar aprotic solvent” is understood to mean, for the purposes of the present invention, a solvent having a dipole moment without an acidic hydrogen atom, that is to say a hydrogen atom bonded to a heteroatom. Preferably in the polar aprotic solvent, the heteroatom is an oxygen atom. Preferentially, the polar aprotic solvent is chosen from ketone solvents, ester solvents and mixtures of these solvents.

More preferentially, the polar aprotic solvent is chosen from dimethylformamide (DMF); acetone, methyl ethyl ketone (also known as butanone), methyl propyl ketone (also known as 2-pentanone), methyl isopropyl ketone (also known as 3-methyl-2-butanone), methyl isobutyl ketone (also known as 4-methyl-2-pentanone), cyclic ketones such as cyclohexanone; tetrahydrofuran (THF); acetonitrile; dimethyl sulfoxide (DMSO) and mixtures thereof. More preferentially, the polar aprotic solvent is chosen from acetone, butanone, 2-pentanone, 3-methyl-2-butanone, 4-methyl-2-pentanone and a mixture thereof. Preferably, the polar aprotic solvent is acetone.

The polar aprotic solvent, preferably the ketone solvents and the ester solvents, are miscible in the hydrocarbon solvent, in particular in the aliphatic hydrocarbon solvent. In other words, the polar aprotic solvent forms a mixture that is homogeneous and stable (to the naked eye) when it is placed in the presence of said hydrocarbon solvent.

According to one embodiment of the invention, the hydrocarbon solvent is the predominant solvent. According to this embodiment, the hydrocarbon solvent is the one which represents the largest amount by weight among the solvents of the composition.

According to another embodiment, the weight ratio of polar aprotic solvent to the hydrocarbon solvent is within a range extending from 15:85 to 85:15 for 100% by weight of solvent, preferably from 30:70 to 70:30 for 100% by weight of solvent, more preferentially from 40:60 to 60:40 for 100% by weight of solvent.

According to one embodiment of the invention, the hydrocarbon solvent is a C4-C14, preferably C5-C10, more preferentially still C7-C9 aliphatic hydrocarbon solvent and the polar aprotic solvent is chosen from acetone, butanone, 2-pentanone, 3-methylbutanone, 4-methyl-2-pentanone and a mixture thereof.

According to another embodiment of the invention, the hydrocarbon solvent is a C5-C10, more preferentially still C7-C9 aliphatic hydrocarbon solvent and the polar aprotic solvent is chosen from butanone, 3-methylbutanone and a mixture thereof.

The anti-ozone protective composition according to the invention may also comprise all or some of the usual additives and processing aids known to a person skilled in the art and generally used in rubber compositions for pneumatic tyres, such as, for example, plasticizers (such as plasticizing oils and/or plasticizing resins), reinforcing or non-reinforcing fillers, pigments, antioxidants, anti-fatigue agents, etc.

Manufacture of the Anti-Ozone Protective Composition and Application Thereof

The process for obtaining the anti-ozone protective composition is simple. The constituents are brought into contact with one another; they are mixed until a homogeneous solution is obtained, that is to say a solution in which there are no suspended particles visible to the naked eye. The order in which the constituents of the protective composition are implemented is not important. Thus, for example, the chlorinated elastomer can first be brought into contact with the hydrocarbon solvent to obtain a mixture, this mixture then being brought into contact with the polar aprotic solvent. Another possibility for manufacturing the composition according to the invention is to bring the two solvents together and then to add the chlorinated elastomer. Once the solution has been well homogenized according to the usual techniques, it can be applied to any crosslinked rubber article or crosslinked elastomeric support. This composition can thus be deposited at ambient temperature (20° C.) by any known means and in particular by brush, by roller or by spraying with a gun. The layer obtained after application is then left to dry; the two solvents evaporate, the elastomer thus deposited forms the protective coating. At ambient temperature (20° C.), the drying time is in particular of the order of 5 min to 10 min, a time which can be further reduced by heating, for example by circulation of hot air or by radiant heating, which complies with maintaining the surface temperature of the rubber article to be protected below 60° C. The dry coating obtained has a high mechanical strength, which enables it to remain in place during storage of the pneumatic tyres until they are put into service.

In order to have the desired thickness of the coating formed after the anti-ozone protective composition has dried, it may be advantageous to apply the composition according to the invention as one or more successive layers.

The desired thickness of the dry coating will vary depending on the elastomeric surface on which the anti-ozone protective composition is applied. Good results are obtained for example with dry coatings having a thickness greater than or equal to 5 μm. Thus, for the groove bottoms of the tread patterns of tyres intended in particular to be fitted to aircraft (these pneumatic tyres in particular crack rapidly under the action of ozone even at rest owing to the high permanent stresses due to the inflation pressure), a thickness within a range extending from 5 μm to 500 μm will be preferred. On the other hand, for an application for example on the outer surface of the sidewalls of a pneumatic tyre, a thickness within a range extending from 5 μm to 50 μm will be sufficient.

Of course, the protective coating cannot be as effective on the parts of the pneumatic tyre in permanent contact with the ground. Thus, if the anti-ozone protective composition is deposited on the entire surface of the tread, the resulting dry coating makes it possible to protect the tread before its use and continues its action on the parts which are not in contact with the ground, therefore in particular the hollow bottoms (grooves) of the tread patterns, the portion of coating covering the tops of the tread patterns directly in contact with the ground being rapidly destroyed since it is subject to wear.

Elastomeric Article.

The anti-ozone protective composition according to the invention can be applied to any type of crosslinked rubber article, preferentially to a crosslinked pneumatic tyre in particular intended to be fitted to aircraft.

Thus, another subject of the present invention relates to a crosslinked elastomeric article comprising at least one elastomeric surface in contact with air, said elastomeric surface being completely or partly coated with an anti-ozone protective composition defined above.

An “elastomeric surface” is understood to mean a surface of an article, this surface being based on at least one elastomer, preferably diene elastomer as defined above, and one other component.

Preferably, the elastomeric article can be any known elastomeric article, and preferentially chosen from pneumatic tyres, in particular those intended to be fitted to aircraft, non-pneumatic tyres, conveyors, seals, shoe soles, caterpillar tracks, tubes, hoses, windscreen wipers, table tennis bats and floor coverings.

A pneumatic tyre is understood to mean a tyre intended to form a cavity in collaboration with a support element, for example a rim, this cavity being able to be pressurized to a pressure higher than atmospheric pressure. In contrast, a non-pneumatic tyre is not able to be pressurized. Thus, a non-pneumatic tyre is a toric body made up of at least one polymer material, intended to perform the function of a tyre but without being subjected to an inflation pressure. A non-pneumatic tyre may be solid or hollow. A hollow non-pneumatic tyre may contain air, but at atmospheric pressure, which is to say that it has no pneumatic stiffness afforded by an inflation gas at a pressure higher than atmospheric pressure.

The pneumatic tyres according to the invention are intended to be fitted to vehicles of any type such as passenger vehicles, two-wheeled vehicles, heavy-duty vehicles, agricultural vehicles, construction plant vehicles or aircraft or, more generally, on any rolling device. The non-pneumatic tyres are intended to be fitted in particular to passenger vehicles or two-wheeled vehicles. Preferably, the pneumatic tyres according to the invention are intended to be fitted to aircraft.

Preferentially, the crosslinked elastomeric article is a crosslinked pneumatic tyre, preferentially intended to be fitted to an aircraft, or a non-pneumatic tyre, at least one outer layer of which has an elastomeric surface at least partly coated with an anti-ozone protective composition defined above. An “outer layer” is understood to mean an elastomeric layer which is in contact with air (other than the inflation gas in the context of a pneumatic tyre); as opposed to the internal layers which are elastomeric layers in contact with one another or in contact with the inflation gas. The outer layer can be the tread of the pneumatic or non-pneumatic tyre, the layer forming the sidewalls of the pneumatic tyre or the spokes in the context of a non-pneumatic tyre.

More preferentially still, the crosslinked elastomeric article is a crosslinked pneumatic tyre, notably intended to be fitted to aircraft, comprising a tread and sidewalls, said tread and/or said sidewalls being at least partly coated with an anti-ozone protective composition defined above. More preferentially, this tread can be retreaded.

### Example

The purpose of this test is to show the protective properties conferred by the compositions of the invention when they are applied to a crosslinked tread of an aircraft pneumatic tyre.

For this, the following compositions C1 to C4 are prepared:

TABLE 1

| Composition | C1 | C2 | C3 | C4 |
|---|---|---|---|---|
| Chlorinated elastomer (1) in g | 5.00 | 10.00 | 15.00 | 20.00 |
| Hydrocarbon solvent (2) in g | 52.25 | 49.50 | 46.75 | 44.00 |
| Polar aprotic solvent (3) in g | 42.75 | 40.50 | 38.25 | 36.00 |

(1): chlorosulfonated polyethylene sold by Lianda under the reference “CSM40” having a Mooney viscosity index of 56 MU, a sulfur content equal to 1%, a chlorine content equal to 35%.
(2): C7-C9 aliphatic hydrocarbon solvent, sold by Total under the reference “Solane 100-155”.
(3): ketone solvent: butanone sold by Fisher Scientific.

Application to a Tyre

A retreaded vulcanized aircraft tyre, referenced PN M05102/IBE and having a development of 4100 mm, uninflated and not mounted on a rim, is used to test the effectiveness of the protective compositions C1 to C4 in accordance with the invention. The tread of this retreaded tyre is conventionally made from a composition based on natural rubber and carbon black. The tread pattern of this tread comprises 4 grooves. On each groove, 5 zones of identical length are marked and the compositions C1 to C4 are applied using a brush in the manner below to the 2^{th} and the 4^{th} groove. The 1^{st} grooves and the 3^{rd} grooves do not include treatment. The first groove is the one closest to the wheel brake disc, in the direction of rotation of the pneumatic tyre, and the 4^{th} groove is the one furthest from the wheel brake disc. After drying at a temperature of 23° C., the thickness of the coating is between 0.05 and 0.10 mm.
2^{th} and 4^{th} groove:
   Zone A: no composition
   Zone B: composition C1
   Zone C: composition C2
   Zone D: composition C3
   Zone E: composition C4

The tyre is then mounted on a rim and is inflated to a pressure of 14.2 bar.

Static Ozone Test

The mounted and inflated tyre is then placed in a thermostated chamber at 23° C. and comprising air in which the ozone concentration is equal to 0.1 ppm (ppm=part per million). After 1 week, the tyre was removed from the chamber to assess the number of cracks in the groove of the tread, then replaced in the same thermostated chamber, doubling the ozone concentration (0.20 ppm) for another week. At the end of this second week, the tyre was removed from the chamber to assess the number of cracks in the groove of the tread, then replaced for another 2 weeks in the same thermostated chamber, the ozone concentration of which is increased to 0.4 ppm. After 4 weeks, the tyre was removed from the chamber to assess the number of cracks in the grooves of the tread.

Airliners fly in an environment that comprises a theoretical ozone concentration of 0.1 ppm. The storage of tyres in the thermostated chamber, beyond the first week under the conditions of the test described above, therefore corresponds to harsher conditions than those that aircraft could encounter in the troposphere (from 2 to 4 times harsher).

The number of cracks is assessed by visual inspection in the following manner:

-: no cracks;

+: ten cracks or less than ten cracks, each crack having a length of less than 10 mm;

++: at least one crack exceeding 10 mm in length.

The results are presented in the Table 2 below.

TABLE 2

| | 2^{th} and 4^{th} groove | | | | |
|---|---|---|---|---|---|
| | Zone A | Zone B | Zone C | Zone D | Zone E |
| 1st week | ++ | − | − | − | − |
| 2nd week | ++ | − | − | − | − |
| 4th week | ++ | + | + | − | − |

It can be seen that zone A, which does not have any protective composition and which corresponds to a control outside the invention, is completely cracked from the first week of storage in contact with ozone. The action of ozone is therefore particularly effective on this zone A of the tread.

On the other hand, surprisingly, on the zones B, C, D and E, of which the surface of the groove has been covered respectively with the protective compositions according to the invention C1 to C4, it is observed that no degradation appears, that is to say, no cracks appear when the tyre has been stored in contact with ozone for one or two weeks in the thermostated chamber.

Under very harsh storage conditions in the presence of ozone, it is observed that zones D and E still do not exhibit any cracks. Compositions C3 and C4 have the advantage of being more protective than compositions C1 and C2, which already offer excellent protection against a high concentration of ozone (0.4 ppm corresponds to 6 times the average ozone concentration in the troposphere).

The protective compositions in accordance with the invention therefore provide very good anti-ozone protection for atmospheres in which the ozone concentrations are very high.

1.-15. (canceled)

16. An anti-ozone protective composition for a crosslinked rubber article, the composition being based on at least one chlorinated elastomer, at least one hydrocarbon solvent and at least one polar aprotic solvent.

17. The anti-ozone protective composition for a crosslinked rubber article according to claim 16, wherein the at least one hydrocarbon solvent is the predominant solvent.

18. The anti-ozone protective composition for a crosslinked rubber article according to claim 16, wherein a weight ratio of the at least one polar aprotic solvent to the at least one hydrocarbon solvent is within a range of from 15:85 to 85:15 for 100% by weight of solvent.

19. The anti-ozone protective composition for a crosslinked rubber article according to claim 16, wherein the at least one hydrocarbon solvent is a C4-C14 aliphatic hydrocarbon solvent.

20. The anti-ozone protective composition for a crosslinked rubber article according to claim 16, wherein the at least one polar aprotic solvent is selected from the group consisting of ketone solvents, ester solvents and mixtures thereof.

21. The anti-ozone protective composition for a crosslinked rubber article according to claim 16, wherein the at least one polar aprotic solvent is selected from the group consisting of acetone, butanone, 2-pentanone, 3-methylbutanone, 4-methyl-2-pentanone and a mixture thereof.

22. The anti-ozone protective composition for a crosslinked rubber article according to claim 16, wherein a content of the at least one chlorinated elastomer in the composition is within a range extending from 3% to 25% by weight relative to the total weight of the composition.

23. The anti-ozone protective composition for a crosslinked rubber article according to claim 16, wherein the at least one chlorinated elastomer is selected from the group consisting of polychloroprene, chlorosulfonated polyethylene and mixtures thereof.

24. The anti-ozone protective composition for a crosslinked rubber article according to claim 16, wherein a chlorine content of the at least one chlorinated elastomer is within a range extending from 20% to 50% by weight relative to the total weight of the elastomer.

25. The anti-ozone protective composition for a crosslinked rubber article according to claim 16, wherein the at least one chlorinated elastomer has a Mooney viscosity index within a range extending from 20 to 100 MU.

26. The anti-ozone protective composition for a crosslinked rubber article according to claim 16, wherein the at least one chlorinated elastomer is a chlorosulfonated polyethylene elastomer having a sulfur content within a range extending from 0.8% to 2% by weight relative to the total weight of the polyethylene.

27. A crosslinked elastomeric article having at least one elastomeric surface in contact with air, the surface being at least partly coated with the anti-ozone protective composition according to claim 16.

28. The crosslinked elastomeric article according to claim 27, wherein the elastomeric article is selected from the group consisting of pneumatic tires, non-pneumatic tires, conveyors, seals, shoe soles, caterpillar tracks, tubes, hoses, windscreen wipers, table tennis bats, and floor coverings.

29. A crosslinked pneumatic or non-pneumatic tire, at least one outer layer of which is at least partly coated with the anti-ozone protective composition according to claim 16.

30. The crosslinked pneumatic or non-pneumatic tire according to claim 29, the at least one outer layer of which is a tread.
